(19) United States
(12) Patent Application Publication
(10) Pub. No.: US 2016/0126707 A1
(43) Pub. Date: May 5, 2016

(54) COVER-LAYER CUTTING APPARATUS

(71) Applicant: Asahi Seiki Co., Ltd., Gifu-shi (JP)

(72) Inventor: Kanji Ishigure, Gifu-shi (JP)

(21) Appl. No.: 14/530,957

(22) Filed: Nov. 3, 2014

(51) Int. Cl. H02G 1/12; B26D 3/28

(52) U.S. Cl. CPC H02G 1/1265; B26D 3/28

(57) ABSTRACT

Disclosed is a cover-layer cutting apparatus that provides a slit in a cover layer of an insulated electric wire. The apparatus includes a disk cutter configured to cut the cover layer, a lifting unit configured to raise and lower the disk cutter in an up-and-down direction (Y-axis direction), and a traversing unit configured to advance and retreat the disk cutter in a right-and-left direction (X-axis direction). The disk cutter is moved by the lifting unit and the traversing unit so that the disk cutter travels on an orbital path along an outer periphery of the electric wire while the disk cutter cuts the cover layer. A contact point of the disk cutter with the cover layer is shifted as a slit is being formed in the cover layer of the electric wire.

### TECHNICAL FIELD AND BACKGROUND OF THE INVENTION

The present invention relates to a cover-layer cutting apparatus that provides a slit in a cover layer of an insulated electric wire at, for example, an end of the electric wire.

There are various types of electric wire that are available, an example of which is an electric wire 52 illustrated in FIG. 13. The electric wire 52 is made up of three layers, namely, a metallic core 52c at the center, an insulating layer 52b covering the core 52c, and a protective layer 52a covering the insulating layer 52b. To connect the electric wire 52 to an electric device or the like, end sections of the insulating layer 52b and the protective layer 52a need to be stripped from the electric wire 52 to allow the end of the electric wire 52 to be attached to a connecting terminal or the like. The protective layer 52a and the insulating layer 52b, the end sections of which are to be stripped, may be referred to as a cover layer herein.

One type of apparatus traditionally used to strip an end section of such a cover layer is a wire-cover stripping apparatus 60 illustrated in FIG. 13. The wire-cover stripping apparatus 60 includes a rectangular cutter 51 arranged symmetrically with respect to the center O of the electric wire 52, so that the cutter 51 holds the electric wire 52 between the upper and lower portions of the cutter 51. With the electric wire 52 held as described above, the cutter 51 is rotated around the electric wire 52 with its rotation axis at the center O of the electric wire 52 and fed gradually into the cover layer as it cuts the cover layer. Once the cutter 51 has been fed to a position near the core 52c and cut accordingly, the cutter 51 is then pulled from this position to strip off end sections of the protective layer 52a and the insulating layer 52b.

For the wire-cover stripping apparatus 60, providing a slit is a time-consuming process because the cutter 51 is rotated around the electric wire 52 and fed gradually into the cover layer as the cutter 51 cuts the cover layer as illustrated in FIG. 13 and described above. Note that a slit as used herein is formed by a cutter to have a depth so near the core that an end section of the cover layer alone can be stripped off with a tool, such as a stripping blade, in a downstream process.

Additionally, the wire-cover stripping apparatus 60 provides a slit in the cover layer around the core 52c by simply allowing the cutter 51 to rotate around the electric wire 52 with its rotation axis at the center O of the electric wire 52 and feeding the cutter 51 gradually into the cover layer as the cutter 51 cuts the cover layer. The wire-cover stripping apparatus 60, thus, can perform this task chiefly for the type of the electric wire 52 including the protective layer 52a, the insulating layer 52b, and the core 52c that are concentric about the center O.

For an electric wire including a core and a cover layer that are not concentric about the center of the electric wire, the wire-cover stripping apparatus 60 may not be able to provide a slit in the cover layer without damaging the core when attempting to provide a slit so deep that stripping-off can be performed. Examples of such an electric wire include an electric wire 32 including an insulating layer 32b and a core 32c having centers deviated from the center O as illustrated in FIG. 5(a) and an electric wire 42 including two cores 42c as illustrated in FIG. 5(b).

### SUMMARY OF THE INVENTION

Disclosed is a highly efficient cover-layer cutting apparatus that can provide a slit in various types of electric wires without damaging the wire's core in an overall reduced time period when compared to traditional apparatuses.

As a solution to the problems described above, the disclosed cover-layer cutting apparatus provides a slit in a cover layer of an insulated electric wire. In certain aspects, the apparatus includes, for example, at least one disk cutter adapted to cut the cover layer of the electric wire; a lifting unit adapted to raise and lower the at least one disk cutter in an up-and-down direction (Y-axis direction); and a traversing unit adapted to advance and retreat the at least one disk cutter in a right-and-left direction (X-axis direction), wherein the at least one disk cutter is moved by the lifting unit and the traversing unit so that the at least one disk cutter travels on an orbital path along an outer periphery of the electric wire while the at least one disk cutter cuts the cover layer of the electric wire, and a contact point of the at least one disk cutter with the cover layer is shifted as a slit is being formed in the cover layer of the electric wire.

In certain aspects, the disk cutter is moved by the lifting unit and the traversing unit so that the disk cutter travels on an orbital path along an outer periphery of an electric wire while the disk cutter cuts a cover layer of the electric wire, and a contact point of the disk cutter with the cover layer is shifted. Thus, the cover-layer cutting apparatus has a cutting velocity higher than that of the traditional wire-cover stripping apparatus 60, as described below with reference to FIGS. 1 and 2. As a result, the cutting amount is increased while the time period for providing the slit is simultaneously and advantageously reduced. As shown in FIGS. 1 and 2 and described in further detail below, in certain aspects the contact point of the disk cutter with the cover layer is shifted regardless of the rotation of the disk cutter around its central point.

Additionally, according to the aspect described above, the disk cutter is also capable of moving around the outer periphery of the electric wire in any X- and Y-axis directions and, thus, providing a slit in cover layers of different types of electric wire, as illustrated in FIGS. 5(a) and 5(b), without damaging their cores.

In certain aspects, the cover-layer cutting apparatus may include a first disk cutter and a second disk cutter each adapted to travel on an orbital path along a substantially half of an outer periphery of a core of the electric wire, and the first disk cutter cuts the cover layer along a substantially half of a circumference of the cover layer and the second disk cutter cuts the cover layer along a substantially remaining half of the circumference of the cover layer, so that a slit is provided along the entire circumference of the cover layer.

According to another aspect, the two disk cutters may each cut the cover layer along a substantially half of the circumference of the electric wire, in place of the one disk cutter traveling around the electric wire in 360 degrees. The disk cutter, which is designed to travel around the electric wire in 360 degrees, may require a complex arrangement to prevent an interference between a component holding the disk cutter and the electric wire. In contrast, the two disk cutters, which are designed to each cut the cover layer along a substantially half of the circumference of the electric wire, cause no interference between the apparatus and the electric wire, allowing for simplicity in the arrangement of the apparatus and achieving a reduction in manufacturing costs of the apparatus.

Additionally, when in use, edge chipping of the two disk cutters is less likely to occur, thus reducing the frequency of cutter grinding. This beneficial result increases the lifespan of the disk cutters and thus reduces the frequency of replacing the cutters, leading to a reduction in parts and labor costs often associated with maintaining these devices.

The first disk cutter and the second disk cutter are each moved by the lifting unit and the traversing unit so that the disk cutters each travel on an orbital path along the outer periphery of the electric wire while the disk cutters each cut the cover layer of the electric wire, and contact points of the disk cutters with the cover layer are shifted.

The cover-layer cutting apparatus may further include a detecting device adapted to detect contact between the core of the electric wire and the first disk cutter and between the core of the electric wire and the second disk cutter, wherein the cover-layer cutting apparatus determines a positional relationship between the core and each of the disk cutters when the detecting device has detected the contact, and the cover-layer cutting apparatus calculates an orbital path on which each of the disk cutters travels along a substantially half of the outer periphery of the core of the electric wire, the orbital paths being based on the respective positional relationships.

According to yet another aspect described above, even when, for example, there are errors in installation of the first and second disk cutters, and when the center position and the radius of the actual core are deviated from their specifications and unknown, positional relationships between the first disk cutter and the core and between the second disk cutter and the core can be measured to obtain discrete orbital paths with respect to the center of the first disk cutter and the center the second disk cutter which are actually installed, respectively. The first and second disk cutters of the cover-layer cutting apparatus then travel on the discrete orbital paths, which have been obtained, to achieve a slit in the cover layer along the entire circumference of the electric wire without damaging the core.

In certain aspects, the disk cutter of the cover-layer cutting apparatus is provided with a rotating device and rotates around a central point of the at least one disk cutter in any direction at any speed.

According to still another aspect described above, by rotating the disk cutter in any direction at any number of rotations, the cutting velocity can be further increased to further reduce a time period taken to provide a slit, or the cutting velocity can be reduced to alleviate wear in the cutting edge, as described below with reference to FIG. 2.

For at least the above discussed reasons, the disclosed apparatus produces superior results by providing a slit in various types of electric wires without damaging the wire's core in a reduced time period when compared to traditional apparatuses.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic illustration of a basic concept of an operation of a disk cutter of a cover-layer cutting apparatus according to the invention;

FIG. 2 is a schematic illustration of a basic concept of an operation of a disk cutter of another exemplary cover-layer cutting apparatus according to the invention;

FIG. 3 is a diagram of a path on which a disk cutter travels when a cover-layer cutting apparatus according to the invention provides a slit in an electric wire;

FIG. 4(a) is a diagram of pulling-off blades to be inserted into a slit provided by the cover-layer cutting apparatus according to the invention to pull off an end section of a cover layer; FIG. 4(b) is a diagram of an electric wire with the end section of the cover layer pulled off;

FIG. 5(a) is a diagram of a different type of electric wire in which a cover-layer cutting apparatus according to the invention provides a slit; FIG. 5(b) is a diagram of another different type of electric wire in which a cover-layer cutting apparatus according to the invention provides a slit;

FIG. 6 is a schematic illustration of a basic concept of operations of disk cutters of a cover-layer cutting apparatus including the two disk cutters according to the invention;

FIG. 7(a) is a diagram for describing how the cover-layer cutting apparatus including the two disk cutters according to the invention provides a slit in a different type of electric wire; FIG. 7(b) is a diagram for describing how the cover-layer cutting apparatus including the two disk cutters according to the invention provides a slit in another different type of electric wire;

FIG. 8(a) is a front view of a cover-layer cutting apparatus including two disk cutters according to the invention; FIG. 8(b) is a front view of a replaceable disk cutter unit including one disk cutter for use with the cover-layer cutting apparatus according to the invention;

FIGS. 9(a) and 9(b) are schematic illustrations for describing a case in which a disk cutter may damage a core of an electric wire while providing a slit because the core is deviated or there is an error in installation of the disk cutter;

FIGS. 10(a) and 10(b) are schematic illustrations for describing an approach to generating an orbital path for the cover-layer cutting apparatus including the two disk cutters according to the invention;

FIG. 11(a) is a schematic illustration of the electric wire illustrated in FIGS. 10(a) and 10(b) observed from its side for describing an arrangement of a detecting device included in the cover-layer cutting apparatus according to the invention; FIG. 11(b) is a circuit diagram formed between electrodes of the disk cutter and an electrode element; FIG. 11(c) is a graph of a change in capacitance between the disk cutter and the electrode element as the disk cutter cuts the electric wire; FIG. 11(d) is a schematic illustration of the disk cutter in contact with the core;

FIGS. 12(a) and 12(b) are schematic illustrations for describing a stripping blade used to pull only an end section of a cover layer off an electric wire after a slit has been provided in the cover layer by the cover-layer cutting apparatus according to the invention;

FIG. 13 is a diagram of an example wire-cover stripping apparatus of the related art; and

FIG. 14 is a schematic illustration of a basic concept of an operation of a cutter of a wire-cover stripping apparatus of the related art.

### REFERENCE SIGNS LIST

1 disk cutter
2 electric wire
2a cover layer
10 cover-layer cutting apparatus
120 traversing unit
140 lifting unit

### DETAILED DESCRIPTION OF THE INVENTION

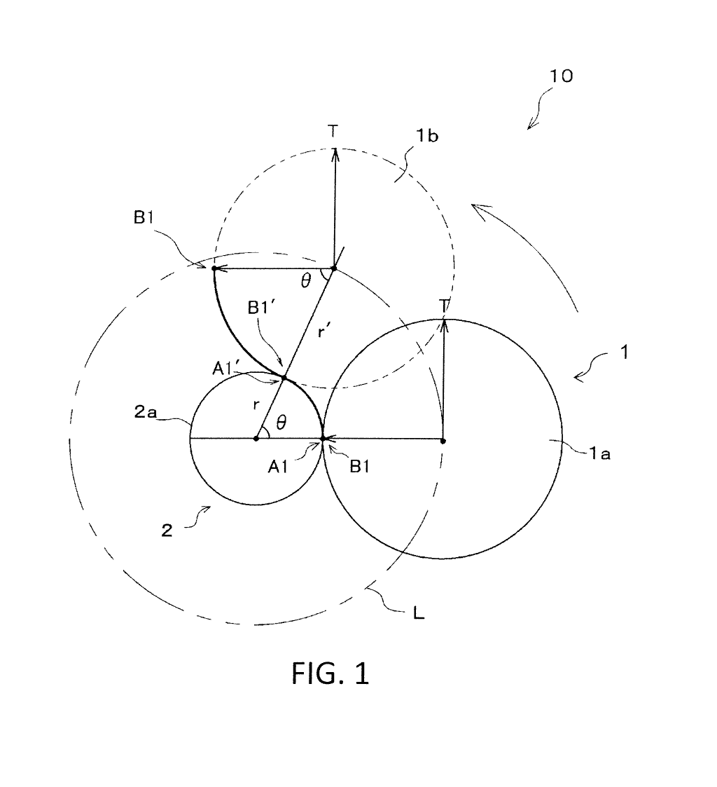

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings. Disclosed is a cover-layer cutting apparatus 10 (see FIG. 1) according to the invention provides a slit in a reduced time period in comparison with the traditional wire-cover stripping apparatus 60 as described below.

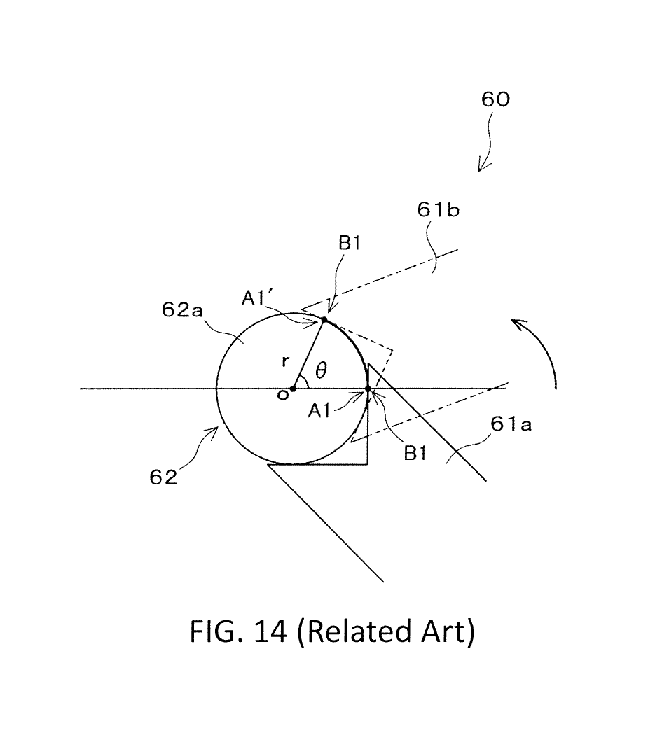

To obtain a cutting velocity V1 of the traditional wire-cover stripping apparatus 60 for comparison, a case is evaluated below, with reference to FIG. 14, in which a cutter 61a is rotated, with its rotation axis at the center O of an electric wire 62, by an angle θ in a direction marked with an arrow for a time period t.

The cutter 61a, when started rotating, starts cutting a cover layer 62a of the electric wire 62 at a position A1 on the outer periphery of the cover layer 62a. The cutter 61a has a contact point B1 with the cover layer 62a. As the cutter 61a, which has started cutting at the position A1, is rotated to achieve a cutter 61b, the cover layer 62a is cut from A1 to A1′.

The cutter 61b, which is after the rotation, still has the contact point B1 with the cover layer 62a. In other words, the cutter 61, which is rotated with its rotation axis at the center O of the electric wire 62, has its contact point remaining at the position B1, which is unchanged on the cutter 61.

Thus, to obtain the cutting velocity V1,

distance A1A1′=rθ, and therefore,

cutting velocity V1=rθ/t,

where r is the radius of the electric wire 62.
A cutting velocity as used herein refers to a cutting amount per unit time.

With reference to FIG. 1, a cutting velocity V2 of the cover-layer cutting apparatus 10 according to the invention is obtained. Here, a circular disk cutter 1 is prevented from rotating around its central point by rotation stopping means (a brake). As the disk cutter 1 cuts a cover layer 2a, the disk cutter 1 is moved around an electric wire 2 along the outer periphery of the electric wire 2, thus moving on a circular path L. The disk cutter 1 is moved on the circular path L for the time period t in a direction marked with an arrow (counterclockwise) by an angle θ.

A disk cutter 1a, which is the disk cutter 1 when started moving, starts cutting the cover layer 2a at a position A1 on the outer periphery of the cover layer 2a. The disk cutter 1a has a contact point B1 with the cover layer 2a. As the disk cutter 1a is moved to achieve a disk cutter 1b, the cover layer 2a is cut to A1′.

While the disk cutter 1a, which is before the movement, has the contact point B1 with the cover layer 2a, the disk cutter 1b, which is after the movement, has a contact point BF with the cover layer 2a. In other words, the contact point of the disk cutter 1 with the cover layer 2a is shifted along a circumference of the disk cutter 1 from B1 toward B1′ (or downward in FIG. 1) as the disk cutter 1 is moved. Thus, the contact point of the disk cutter 1 with the cover layer 2a is shifted as a slit is being formed in the cover layer 2a of the electric wire 2. Note that the disk cutter 1 is stopped from rotating around its central point, as apparent from a top T, which does not shift in position on the disk cutter 1a and on the disk cutter 1b after the movement.

Thus, to obtain the cutting velocity V2,

distance A1A1′=rθ,

distance B1B1′=r′θ, and therefore,

cutting velocity V2=(A1A1′+B1B1′)/t

=rθ/t+r′θ/t,

where r′ is the radius of the disk cutter 1.
This indicates clearly that the cutting velocity V2 of the cover-layer cutting apparatus 10 according to the invention is higher than the cutting velocity V1 of the traditional wire-cover stripping apparatus 60. With the higher cutting velocity, the cutting amount is increased, leading to a reduction in time period taken to provide a slit in a cover layer of an electric wire.

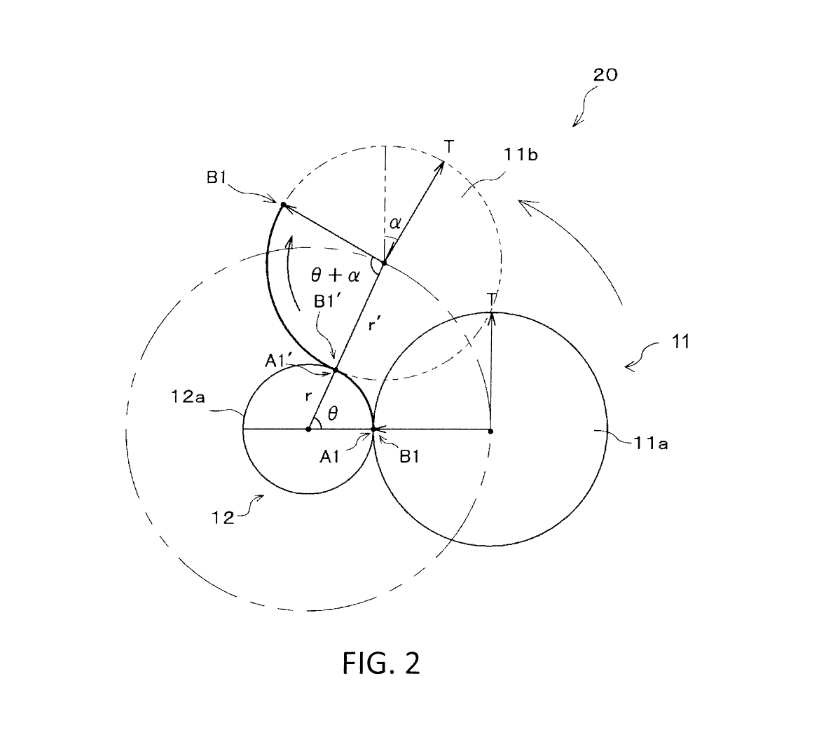

With reference to FIG. 2, a cutting velocity V3 of a cover-layer cutting apparatus 20 according to the invention is obtained. In this case, a disk cutter 11 is rotated around its central point by a rotating device. The disk cutter 11 is turned (around its central point) clockwise for the time period t by an angle α. Otherwise, the cover-layer cutting apparatus 20 operates in the same manner as the cover-layer cutting apparatus 10 illustrated in FIG. 1. In the case of the cover-layer cutting apparatus 20, the contact point of the disk cutter 11 with a cover layer 12a is shifted more than that in FIG. 1 by the turn of the disk cutter 11 or by ea. A distance B1B1′ over which the contact point of the disk cutter 11b is shifted in FIG. 2 is larger than the distance B1B1′ over which the contact point of the disk cutter 1b is shifted in FIG. 1. With the disk cutter 11 being rotated around its central point, the contact point of the disk cutter 11 with the cover layer 12a is shifted as a slit is being formed in the cover layer 12a of the electric wire 12 as in FIG. 1.

Thus, to obtain the cutting velocity V3,

distance A1A1′=rθ,

distance B1B1′=r′|θ+α|, and therefore,

cutting velocity V3=(A1A1′+B1B1′)/t

=rθ/t+r′|θ+α|/t.

This indicates that, by rotating the disk cutter 11, the cutting velocity V3 is further increased so as to be higher than the cutting velocity V2. This leads to a further reduction in time period taken to provide a slit in a cover layer of an electric wire.

Although the disk cutter 11 is rotated around its central point clockwise in FIG. 2, the disk cutter 11 may of course be rotated counterclockwise. In such a case, since the angle α is positive when the disk cutter 11 is turned clockwise, a counterclockwise turn larger than the angle θ results in a negative distance B1B1′ mathematically. Thus, the absolute value of the distance B1B1′ is used. Where the disk cutter 11 is turned counterclockwise, if the angle α is within a range that satisfies the condition of θ<|θ+α|, then the cutting velocity V3 is higher than the cutting velocity V2.

Where the disk cutter 11 is rotated counterclockwise, if the disk cutter 11 is turned so that the cutting velocity V3 is lower than the cutting velocity V2 (or if the angle α is given in that manner), wear in the cutting edge of the disk cutter 11 can be alleviated, leading to a prolonged life of the disk cutter. Note that, since V2>V3, the condition of θ>|θ+α| needs to be satisfied.

Additionally, where the disk cutter 11 is rotated counterclockwise, if the disk cutter 11 cuts the cover layer 12a while the disk cutter 11 is in rolling contact with the cover layer 12a, wear in the cutting edge of the disk cutter 11 and cutting resistance are minimized. Specifically, the distance A1A1′ over which the disk cutter 11 is moved on the cover layer 12a during the time period t should be equal to the distance B1B1′ over which the contact point of the disk cutter 11b is shifted during the time period t, and thus, the condition of rθ=r′|θ+α| needs to be satisfied. As described above, by using the rotating device, the disk cutter 11 can be rotated in any direction of rotation at any number of rotations, thereby allowing for optimal cutting operations suitable for needs.

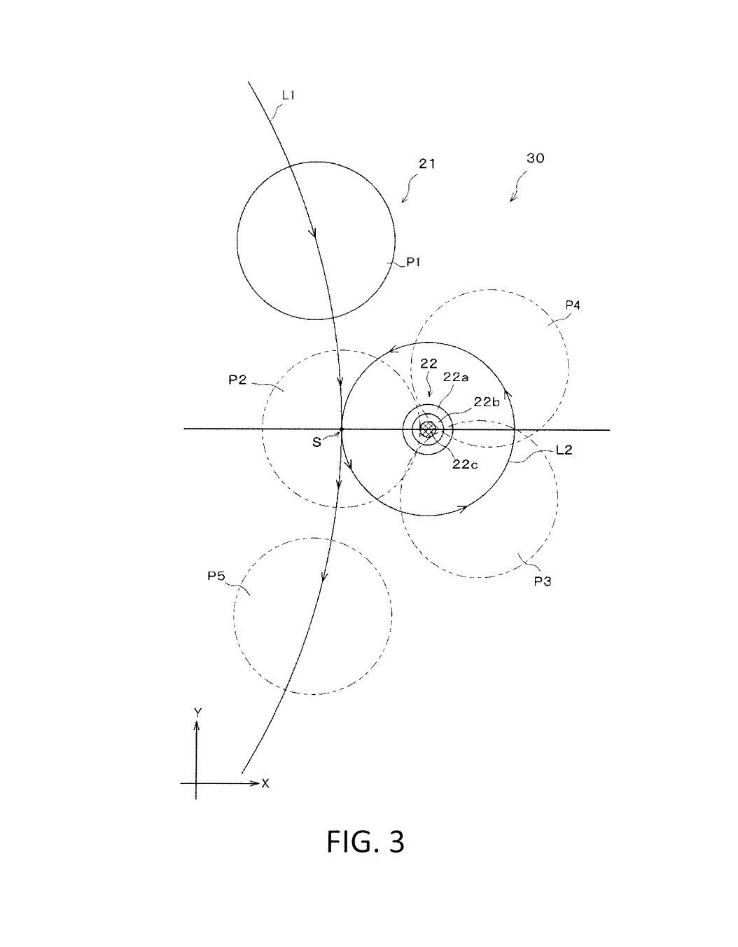

With reference to FIG. 3, exemplary paths are described on which a disk cutter 21 of a cover-layer cutting apparatus 30 according to the invention travels when providing a slit in an electric wire 22. In FIG. 3, a circular path L1 is in contact with a circular path L2 at a point of contact S. The circular path L2 is around the electric wire 22. The disk cutter 21 travels on the circular path L1 from a position P1 toward a position P2 to approach the electric wire 22. Upon arrival at the position P2, the disk cutter 21 changes its path to travel on the circular path L2 to a position P3 and then to a position P4. Since the disk cutter 21 travels on the circular paths L1 and L2 in this manner, the disk cutter 21 can start cutting a cover layer including a protective layer 22a and a insulating layer 22b smoothly. When the disk cutter 21 has arrived at the position P2 again, the disk cutter 21 changes its path to travel on the circular path L1 toward a position P5.

The circular paths L1 and L2 are defined by XY coordinate values, and, thus, by adjusting the coordinate values, a path suitable for a type of electric wire can be generated with ease. The travel of the disk cutter 21 in X and Y directions is controlled by a lifting unit and a traversing unit so that the disk cutter 21 travels on the paths.

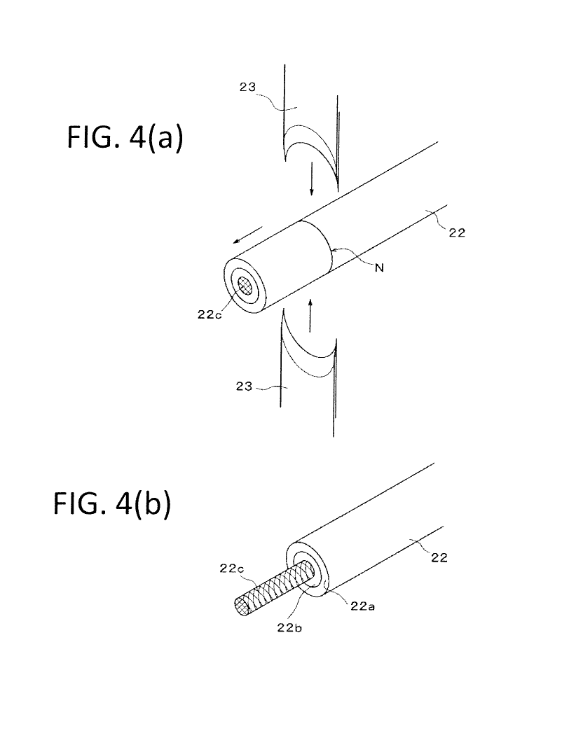

Once the disk cutter 21 has provided a slit N in the cover layer of the electric wire 22 (see FIG. 3), an end section of the cover layer is pulled off as illustrated in FIG. 4(a). Pulling-off blades 23 are inserted into the slit N of the electric wire 22 vertically. The pulling-off blades 23, as inserted, are then moved toward the end of the electric wire 22. In this manner, the end section of the cover layer only (the protective layer 22a and the insulating layer 22b) is pulled off, leaving the core 22c behind at the end of the electric wire 22, as illustrated in FIG. 4(b).

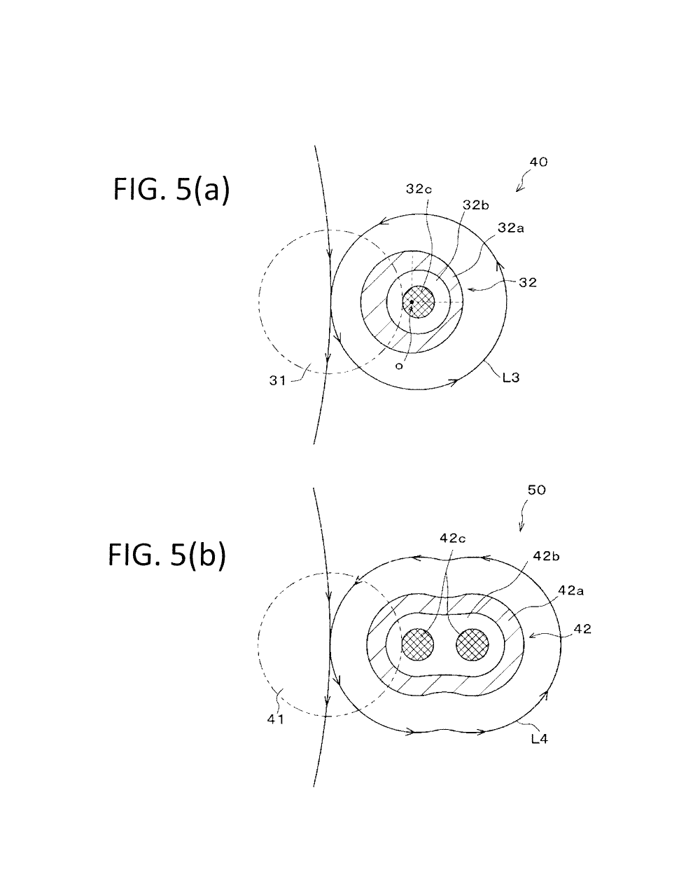

In FIGS. 5(a) and 5(b), a slit is provided in different types of electric wire. With reference to FIG. 5(a), an electric wire 32 includes an insulating layer 32b and a core 32c having centers deviated from the center O of the electric wire 32. The traditional wire-cover stripping apparatus 60 would have difficulty in providing a slit in a cover of the electric wire 32, because this apparatus, which rotates the cutter around the electric wire 32 with its rotation axis at the center O while the cutter cuts the electric wire 32 until there is a slit sufficient to strip off an end section of the cover, would damage the core 32c.

A cover-layer cutting apparatus 40 according to the invention does not have this difficulty, because its disk cutter 31 travels on a path L3 around the electric wire 32 along the outer periphery of the electric wire 32. The cover (a protective layer 32a and an insulating layer 32b) of the electric wire 32 has different thicknesses at the right and left sides of the center O. When the disk cutter 31 is at the left side of the electric wire 32 with the cover having a larger thickness, the rotating device can be used to increase the number of rotations of the disk cutter 31 to increase the cutting velocity and thereby the cutting amount. For an electric wire including a cover made up of different materials with differences in hardness, rotating means can be used to, for example, increase the number of rotations of the cutter to increase the cutting velocity and thereby the cutting efficiency when the cutter is at a cover material having a greater hardness. Alternatively, the rotating means can be used to reduce the number of rotations to mitigate wear in the cutting edge. The number of rotations of the cutter can be adjusted optimally to usage as appropriate.

With reference to FIG. 5(b), an electric wire 42 includes two cores. The traditional wire-cover stripping apparatus 60 would have difficulty in providing a slit in a cover (a protective layer 42a and an insulating layer 42b) of the electric wire 42, because this apparatus, if used to cut the electric wire 42 until there is a slit sufficient to strip off an end section of the cover, would damage the cores 42c. In contrast, a cover-layer cutting apparatus 50 according to the invention is capable of providing a slit in the cover, because its disk cutter 41 travels on a path L4 around the electric wire 42 along the outer periphery of the electric wire 42.

A cover-layer cutting apparatus including two disk cutters will now be described. The cover-layer cutting apparatus including two disk cutters differs from the cover-layer cutting apparatuses 10 to 50, each of which includes one disk cutter, in a traveling track (orbital path) of each disk cutter. Note that the two disk cutters are capable of rotating independently around their respective central points as described in FIGS. 2, 3, 5(a) and 5(b), and their respective speeds and directions of rotation can be adjusted as appropriate.

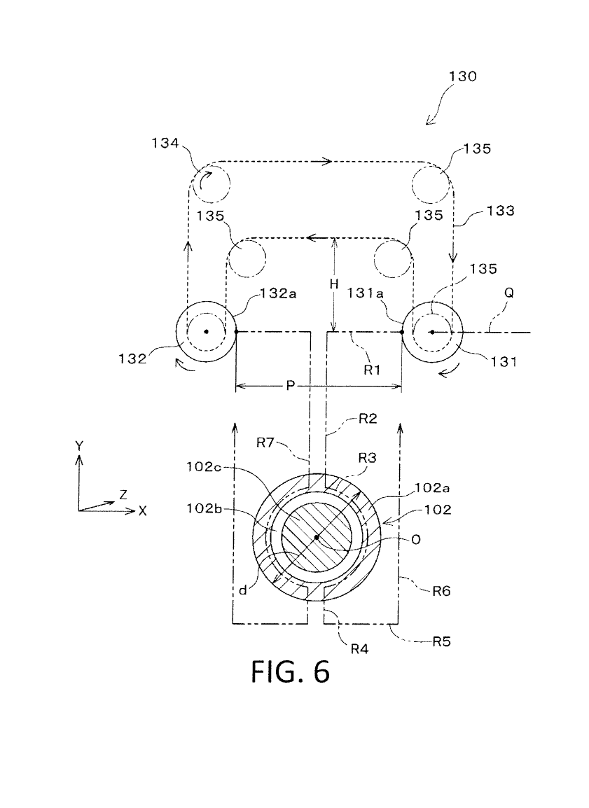

FIG. 6 is a front view for describing an embodiment of the cover-layer cutting apparatus including two disk cutters. Vertical directions in this figure are directed toward the top and the bottom of the apparatus. A right-and-left direction in this figure is referred to as an X-axis direction, an up-and-down direction as a Y-axis direction, and a direction perpendicular to the plane of the sheet as a Z-axis direction.

As illustrated in FIG. 6, an electric wire 102 includes a protective layer 102a, an insulating layer 102b, and a core 102c. A first disk cutter 131 and a second disk cutter 132 are above the electric wire 102.

An endless timing belt 133 represented by a broken line in the figure has a substantially U-shaped running path with an opening facing downward. The running path of the timing belt 133 is shaped by the arrangement of one drive pulley 134 and five guide pulleys 135 so that there are an opening width P, between the cutters 131 and 132, that allows for the entry of the electric wire 102 by a sufficient margin and a depth H that allows a lower end of the electric wire 102 to exceed a common center line Q of the cutters by a sufficient margin. The cutters 131 and 132, the timing belt 133, the drive pulley 134, and the guide pulleys 135 constitute a disk cutter unit 130.

With the drive pulley 134 driven clockwise as marked with an arrow by an undepicted device, such as a servomotor, the timing belt 133 runs in a loop along the illustrated path, enabling the first disk cutter 131 and the second disk cutter 132 to also rotate clockwise. Changing the rotational speed of the drive pulley 134 changes the running speed of the timing belt 133, allowing for easy adjustment of the rotational speeds of the cutters 131 and 132 to cut the protective layer 102a and the insulating layer 102b to optimal speeds. In other words, the drive pulley 134 is a rotating device to enable the first disk cutter 131 and the second disk cutter 132 to rotate around their respective central points in any rotational direction at any rotational speed.

Tracks R1 to R6 constitute a traveling track of a cutting edge 131a of the first disk cutter 131. The cutting edge 131a, while the first and second disk cutters 131 and 132 are rotating (around their respective central points) in the illustrated positions, starts traveling to the left on the track R1, then downward on the track R2 to reach a top of the electric wire 102 and cut the protective layer 102a and the insulating layer 102b by their thicknesses, then travels (on an orbital path) around the core 102c clockwise on the track R3, which is along a substantially right half of the outer periphery surface of the core 102c, then travels downward on the track R4 to leave the core 102c, and then travels on the tracks R5 and R6 to return to the original position.

In this manner, the protective layer 102a and the insulating layer 102b are cut along a substantially right half of the circumference of the electric wire 102 with the traveling track R1 to R6 of the first disk cutter 131.

A traveling track R7, which is for a cutting edge 132a of the second disk cutter 132, and the traveling track R1 to R6, which is for the first disk cutter 131 described above, have line symmetry with respect to a perpendicular passing the center O of the electric wire 102. The protective layer 102a and the insulating layer 102b can be cut along a substantially remaining half of the circumference of the electric wire 102 with the traveling track R7 in a similar manner as described above.

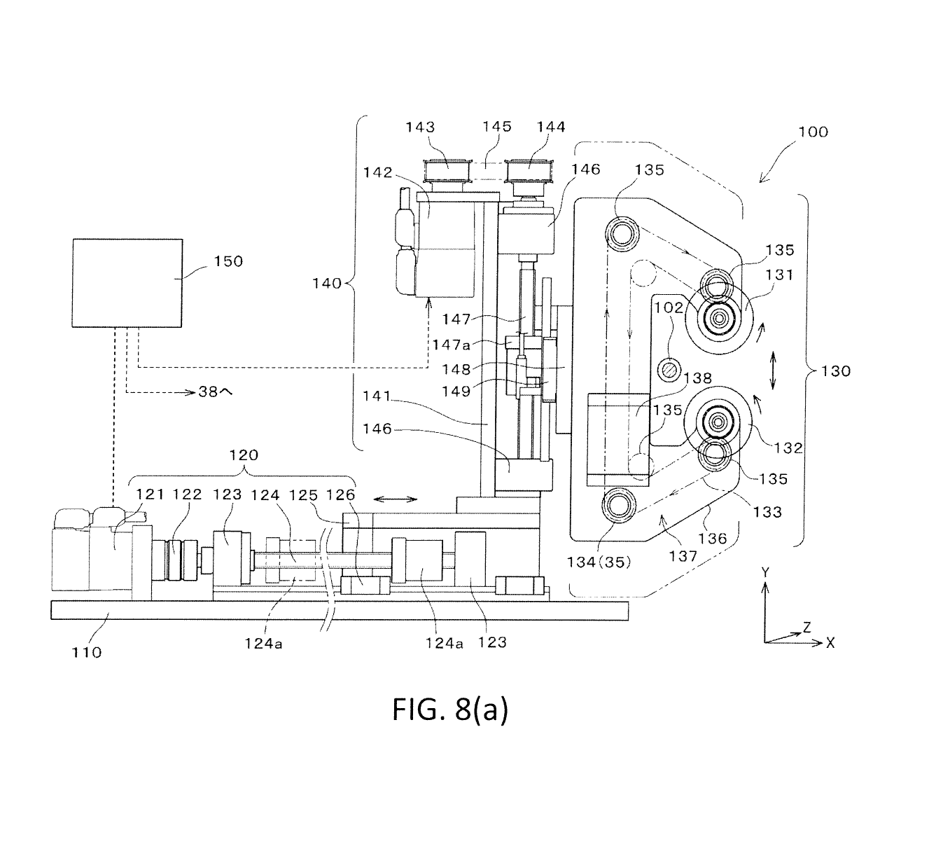

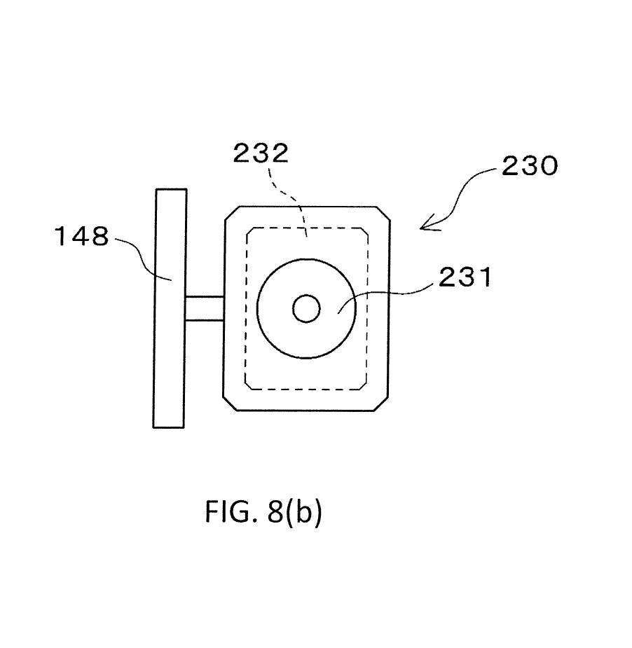

Such traveling tracks R1 to R6 and R7 can be achieved with ease by controlling the position of the disk cutter unit 130 (see FIG. 8(a)), which supports the first and second disk cutters 131 and 132 rotatably, in two directions of X- and Y-axes simultaneously.

Through such a cutting method, the first disk cutter 131 and the second disk cutter 132 each cut a cover layer (the protective layer 102a and the insulating layer 102b) of the electric wire 102 along a substantially half of the circumference of the cover layer, and thus, the two cutters 131 and 132 together can provide a slit in the cover layer along the entire circumference of the cover layer.

Note that a gap in the figure between the traveling track R1 to R6 of the first disk cutter 131 and the traveling track R7 of the second disk cutter 132 is provided for convenience in description. The traveling tracks actually overlap with each other to some extent to provide a slit all the way around the outer periphery surface of the core 102c reliably.

Alternatively, the first disk cutter 131 may be used to cut the protective layer 102a and the insulating layer 102b in a range exceeding a half of the circumference of the cover layer to some extent, and then the second disk cutter 132 is used to cut the remainder. This process may be reversed. In essence, the two disk cutters 131 and 132 are used to complement each other to provide a slit all the way around the protective layer 102a and the insulating layer 102b. A range in which the first and second disk cutters 131 and 132 each travel around the protective layer 102a and the insulating layer 102b is described as a “substantially half” of the circumference of the cover layer herein in the sense described above.

Once a slit has been provided all the way around the protective layer 102a and the insulating layer 102b, then end sections of the protective layer 102a and the insulating layer 102b are removed from the core 102c in the manner illustrated in FIGS. 4(a) and 4(b).

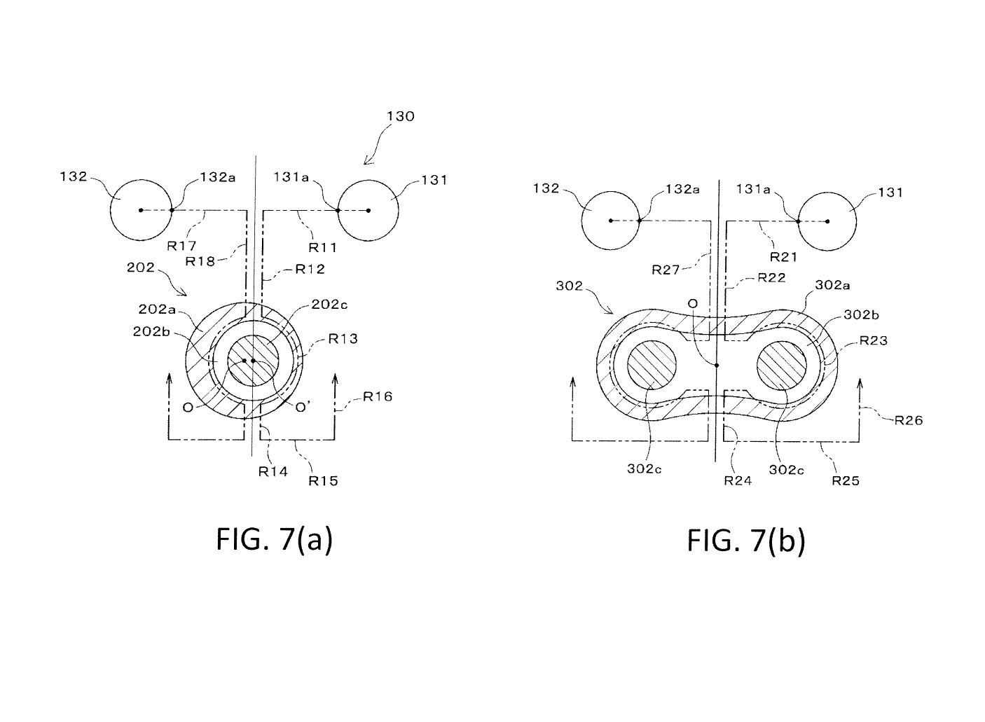

FIGS. 7(a) and 7(b) are diagrams for describing how the cover-layer cutting apparatus including the two disk cutters according to the invention provides a slit in different types of electric wire. An electric wire 202 in FIG. 7(a) includes a cover layer, made up of a protective layer 202a and an insulating layer 202b, and a core 202c, and the protective layer 202a, the insulating layer 202b, and the core 202c have centers deviated from the center O of the electric wire 202. An electric wire 302 in FIG. 7(b) includes more than one core 302c.

The cover-layer cutting apparatus according to the invention is capable of providing a path that causes no damage to the core or cores, because the apparatus is capable of controlling the position of the disk cutter unit 130 (see FIG. 8(a)), which supports the first and second disk cutters 131 and 132 rotatably, in the two directions of X- and Y-axes simultaneously.

Specifically, as illustrated in FIG. 7(a), while the cutters are both rotating (around their respective central points), the cutting edge 131a starts traveling to the left on a track R11. The track R11 extends from the cutting edge 131a to a perpendicular passing the center O′ of the core 202c. The cutting edge 131a then travels downward on a track R12 to reach a top of the electric wire 202 and cut the protective layer 202a and the insulating layer 202b by their thicknesses, then travels (on an orbital path) around the core 202c clockwise on a track R13, which is along a substantially right half of the outer periphery surface of the core 202c, then travels downward on a track R14 to leave the core 202c, and then travels on tracks R15 and R16 to return to the original position.

A traveling track R17 extends from a cutting edge 132a of the second disk cutter 132 to the perpendicular passing the center O′ of the core 202c, and has an identical traveling distance with the traveling track R11 for the first disk cutter 131 described above. A track R18 and the traveling tracks R12 to R16, which are for the first disk cutter 131 described above, have line symmetry with respect to the perpendicular passing the center O′ of the core 202c. The protective layer 202a and the insulating layer 202b can be cut along a substantially remaining half of the circumference of the electric wire 202 with the traveling tracks R17 to R18.

With the reference to FIG. 7(b), tracks R21 to R26 constitute a traveling track of the cutting edge 131a of the first disk cutter 131. The cutting edge 131a, while the first and second disk cutters 131 and 132 are rotating (around their respective central points) in the illustrated positions, starts traveling to the left on the track R21. The cutting edge 131a then travels downward on the track R22. While traveling from a middle of the electric wire 302 toward the right, the cutting edge 131a then cuts a protective layer 302a and an insulating layer 302b by their thicknesses, then travels (on an orbital path) clockwise on the track R23, which is along the outer periphery surface of the right-side core 302c, then travels downward on the track R24 to leave the core 302c, and then travels on the tracks R25 and R26 to return to the original position.

A traveling track R27, which is for the cutting edge 132a of the second disk cutter 132, and the traveling tracks R21 to R26, which are for the first disk cutter 131, have line symmetry with respect to a perpendicular passing the center O of the electric wire 302. The protective layer 302a and the insulating layer 302b, which constitute a cover layer of the electric wire 302, can be cut along a substantially remaining half of the circumference of the electric wire 302 with the traveling track R27 in a similar manner as described above.

With reference to FIG. 8(a), an arrangement of a cover-layer cutting apparatus including the two disk cutters according to the invention will now described.

FIG. 8(a) is a front view of a cover-layer cutting apparatus 100. Vertical directions in this figure are directed toward the top and the bottom of the apparatus. As in FIG. 6, a right-and-left direction is referred to as the X-axis direction, an up-and-down direction as the Y-axis direction, and a direction perpendicular to the plane of the sheet as the Z-axis direction. The electric wire 102, a longitudinal section of which is illustrated, is secured by an undepicted clamping device.

The cover-layer cutting apparatus 100 according to the invention includes a base 110, a disk cutter unit 130, a lifting unit 140 adapted to raise and lower the entire disk cutter unit 130 in the up-and-down direction (Y-axis direction), a traversing unit 120 adapted to advance and retreat the disk cutter unit 130 together with the lifting unit 140 in the right-and-left direction (X-axis direction), and a control panel 150 (X/Y-axis direction control device) adapted to provide commands of drive in the X- and/or Y-axis direction to servomotors of the units 120, 130, and 140 so that these units are in predetermined positions in the two directions of X- and Y-axes.

To describe the components specifically, the base 110, which serves as a common base for the cover-layer cutting apparatus 100 according to the invention, is shaped into a rectangle having longer sides orthogonal to an axial direction of the electric wire 102 and secures the traversing unit 120 thereon.

The traversing unit 120, which is adapted to advance and retreat the disk cutter unit 130 together with the entire lifting unit 140 in the right-and-left direction (X-axis direction), includes a traversing servomotor 121 and its coupling 122, a right-and-left pair of bearings 123 and 123, a ball screw unit 124 supported between the bearings 123 and 123, a support block 125 secured to a nut 124a of the ball screw unit for supporting the lifting unit 140, and an LM guide 126 adapted to guide the support block 125 in the right-and-left direction.

With the traversing servomotor 121 rotating in either direction of rotation, the ball screw unit 124 is rotated accordingly, causing the nut 124a to traverse from a position marked with a solid line to a position marked with a chain double-dashed line. The nut 124a causes the support block 125 to slide on the LM guide 126 in the right-and-left direction. Since the entire lifting unit 140 is secured on the support block 125, the lifting unit 140 is also allowed to slide in the right-and-left direction (X-axis direction).

The lifting unit 140, which is adapted to raise and lower the entire disk cutter unit 130 in the up-and-down direction (Y-axis direction) between the chain double-dashed lines illustrated in the figure, has a similar arrangement to the traversing unit 120 of the disk cutter unit 130, in principle.

Specifically, the lifting unit 140 includes a lifting slide base 141 provided on the support block 125, a lifting servomotor 142 secured on an upper portion of the lifting slide base 141, a driving timing pulley 143 of the servomotor, a following timing pulley 144, a timing belt 145 over the pulleys, an upper and lower pair of bearings 146 and 146, a ball screw unit 147 supported between the bearings 146 and 146, a support block 148 secured to a nut 147a of the ball screw unit for supporting the disk cutter unit 130, and an LM guide 149 supporting the support block 148 and adapted to guide the support block 148 in the up-and-down direction.

With the lifting servomotor 142 rotating in either direction of rotation, the driving timing pulley 143 is driven, and its drive torque is transmitted by the timing belt 145 to the following timing pulley 144, causing the ball screw unit 147 to rotate accordingly. Because of the rotation of the ball screw unit 147, its nut 147a causes the support block 148 to move up and down.

When the support block 148 is moved up and down, the entire disk cutter unit 130 moves up and down from a position marked with a solid line between positions marked with the chain double-dashed lines.

The disk cutter unit 130 is adapted to cut a protective layer 102a and an insulating layer 102b along a substantially half of the circumference of the electric wire 102 at a time, so that a slit is provided along the entire circumference of the electric wire 102 eventually. Although the arrangement and orientation of the components of the disk cutter unit 130 are different from that in FIG. 6, a slit is provided according to the same basic principle.

Alternatively, a disk cutter unit 230 illustrated in FIG. 8(b), in place of the disk cutter unit 130, may be attached to the support block 148. The disk cutter unit 230 includes a disk cutter 231 and a servomotor 232, which serves as a rotating device to enable the disk cutter 231 to rotate around its central point. The servomotor 232 can rotate in any direction at any rotational speed, allowing the disk cutter 231, which is connected thereto, to rotate at any direction at any rotational speed accordingly. The servomotor 232 includes a built-in brake that can immobilize the disk cutter 231 to prevent it from rotating.

As described above, the cover-layer cutting apparatus 100 is capable of controlling the position of the disk cutter unit 130 in the X and Y directions and thus of allowing a first disk cutter 131 and a second disk cutter 132, attached to the disk cutter unit 130, to travel on any path through the position control in the X and Y directions as illustrated in FIGS. 6, 7, 9(a), 10(a) and 10(b). Additionally, the cover-layer cutting apparatus 100 is, when the disk cutter unit 230 illustrated in FIG. 8(b) is attached thereto, capable of controlling the position of the disk cutter unit 230 in the X and Y directions and thus of allowing the disk cutter 231 to travel on any path through the position control in the X and Y directions as illustrated in FIGS. 3, 5(a) and 5(b).

An approach will now be described to using a detecting device to generate an orbital path along which a disk cutter can provide a slit without damaging a core even when an electric wire is different from its specification in center position and diameter, and when there is an error in installation of the disk cutter.

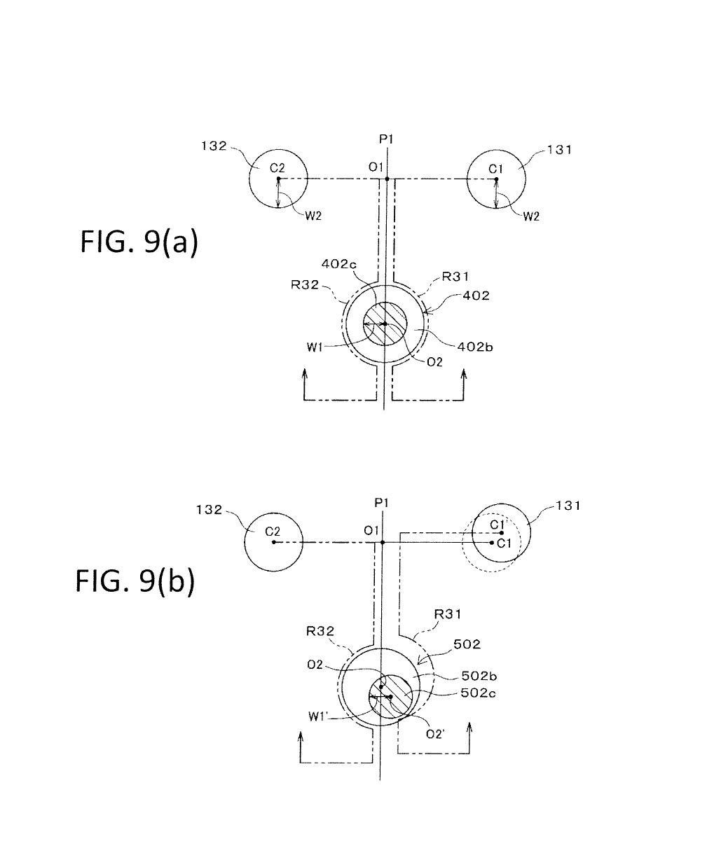

With reference to FIG. 9(a), orbital paths of disk cutters will be described for a case in which a core is not eccentric and the center position and the diameter of the core are ideal and made to their specifications. A first disk cutter 131 and a second disk cutter 132 are also assembled accurately to have line symmetry with respect to a symmetry axis P1 with a point O1 at the center.

To provide a slit in an insulating layer 402b alone without damaging a core 402c of an electric wire 402 in FIG. 9(a), the first disk cutter 131 travels on an orbital arc-shaped path R31, which is away from the center O2 of the core 402c by a certain distance (W1+W2). The second disk cutter 132 then travels on a path R32, which is an orbital path that has line symmetry with the path R31 with respect to the symmetry axis P1 passing the center O2. Here, W1 represents the radius of the core 402c, and W2 represents the radius of the first disk cutter 131 or the second disk cutter 132. Although the arc-shaped path R31 is away from the center O2 of the core 402c by the certain distance (W1+W2) in this embodiment, the arc-shaped path R31 may be further away by a short distance α, in other words, the arc-shaped path R31 may be a path away from the center O2 of the core 402c by a certain distance (W1+W2+α), depending on conditions. Note that this applies to the paths of the other disk cutters described herein.

FIG. 9(b) assumes a case in which an actual center O2′ of a core 502c of an electric wire 502 is deviated from a specified center O2 and an actual radius W1′ of the core 502c is deviated from a specified radius W1, and a case in which an actual center C1′ of a first disk cutter 131 is deviated from a designed center C1 of the first disk cutter 131, resulting from shifted installation of the first disk cutter 131.

The first disk cutter 131, which starts traveling from a starting point at the center C1′ then on an orbital path R31, may fail to cut an insulating layer 502b reliably and may damage a core 502c as illustrated in FIG. 9(b). Additionally, the second disk cutter 132, which travels on an orbital path R32, may fail to cut the insulating layer 502b reliably and may damage the core 502c as illustrated in FIG. 9(b) because of the deviation of the core 502c.

In other words, the use of the orbital paths R31 and R32 obtained on the basis of the specified center position and radius of the core and the designed position of the disk cutter may experience the problems described above.

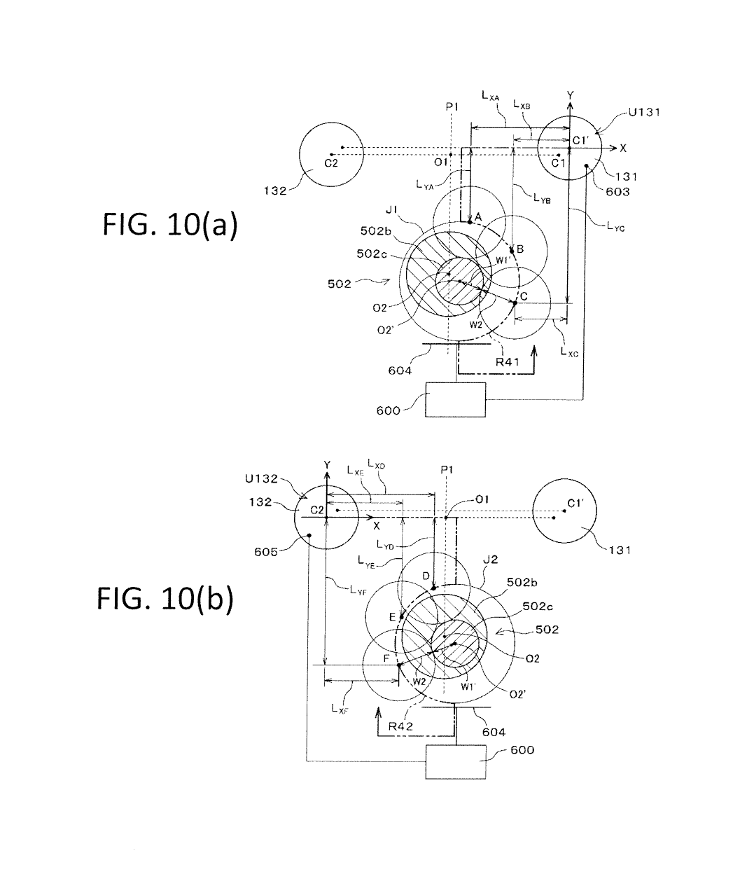

With reference to FIGS. 10(a) and 10(b), an approach to generating orbital paths along which a first disk cutter 131 and a second disk cutter 132 cut an insulating layer 502b reliably without damaging a core 502c will now be described in detail. Note that W1′ is the actual radius of the core 502c.

With reference to FIG. 10(a), an orbital path R41 for the first disk cutter 131 is obtained. A center C1′ of the first disk cutter 131 is deviated from a designed center C1 due to an error in installation.

The first disk cutter 131 starts traveling from a starting point at the center C1′ in the X direction by a distance L_{XA}. The first disk cutter 131 then travels in the Y direction by a distance L_{YA} to cut the insulating layer 502b until the first disk cutter 131 comes in contact with the core 502c. The position of the center of the first disk cutter 131 at the time of the contact is defined as a center position A.

Specifically, the contact between the first disk cutter 131 and the core 502c can be detected by a detecting device 600. Upon detection of the contact, the first disk cutter 131 stops traveling in the Y direction and the distance L_{YA} that has been traveled is measured. In an XY coordinate system U131 set with the origin at the center C1′ of the first disk cutter 131, the center position A is described as (−L_{XA}, −L_{YA}) in the XY coordinates. The center position A represents a positional relationship between the first disk cutter 131 and the core 502c in the XY coordinate system U131.

Subsequently, to measure other center positions in addition to the center position A, the first disk cutter 131 repeats the process of traveling in the XY directions from the center C1′ to a position in contact with the core 502c. This process yields a center position B (−L_{XB}, −L_{YB}) and a center position C (−L_{XC}, −L_{YC}) of the first disk cutter 131 in contact with the core 502c.

As illustrated in FIG. 10(a), the center positions A, B, and C are on the circumference of a circle J1 having its center on the center O2′ of the core 502c and a radius (W1′+W2). The center and the radius of the circle J1 can be calculated from the coordinates of the center positions A, B, and C.

Specifically, a perpendicular bisector of a line segment bounded by the center positions A and B and a perpendicular bisector of a line segment bounded by the center positions B and C intersect at the center O2′. Thus, the point of the intersection of the two perpendicular bisectors described above is calculated to obtain the coordinates of the center O2′. As described above, the XY coordinates for the center O2′ of the circle J1 can be calculated from the coordinates of the center positions A to C. Then, the distance from the center O2′ to the center position C (alternatively, center position A or B) is calculated to obtain the radius of the circle J1.

As illustrated in FIG. 10(a), a substantially right half arc of the circle J1 having the center and the radius thus calculated will serve as the orbital path R41 on which the first disk cutter 131 travels, while cutting, without damaging the core 502c. The path R41 is defined by the XY coordinates in the XY coordinate system U131. Subsequently, the first disk cutter 131 starts traveling from the starting point at the center C1′ and then on the orbital path R41, which has been obtained, as illustrated in FIG. 10(a), so that the first disk cutter 131 can cut the insulating layer 502b, which is a cover layer, without damaging the core 502c.

As described above, even when the actual center C1′ of the first disk cutter 131 is deviated from the designed center C1 due to an installation error and when the center O2′ of the core 502c is deviated from the specified center O2, the first disk cutter 131 can cut the insulating layer 502b without damaging the core 502c by measuring the positional relationship between the actual center C1′ and the electric wire 502 and obtaining the path R41 with respect to the center C1′ as described above.

With reference to FIG. 10(b), an orbital path R42 for the second disk cutter 132 is obtained. The second disk cutter 132 is assembled in position to the design without an installation error. The core 502c, however, has the deviated center position and its accurate radius is unknown, and thus it is demanded that the orbital path R42 be obtained along which the second disk cutter 132 cuts the insulating layer 502b reliably without damaging the core 502c. Although no installation error is assumed in the second disk cutter 132 here, an approach described below may be still used in the event of such an error to generate a path that causes no damage to the core 502c, as in the case with the first disk cutter 131.

The path R42 for the second disk cutter 132 is obtained in the same manner as the path R41 for the first disk cutter 131, in which approach has been described with reference to FIG. 10(a), and thus the following description will be brief.

The second disk cutter 132 starts traveling from a starting point at a center C2 in the X direction by a distance L_{XD} as illustrated in FIG. 10(b). The second disk cutter 132 then travels in the Y direction by a distance L_{YD} until the detecting device 600 detects contact between the second disk cutter 132 and the core 502c at a center position D.

In an XY coordinate system U132 set with the origin at the center C2 of the second disk cutter 132, the center position D is described as (L_{XD}, −L_{YD}) in the XY coordinates. The second disk cutter 132 repeats the process of traveling in the XY directions from the center C2 to a position in contact with the core 502c to obtain a center position E (L_{XE}, −L_{YE}) and a center position F (L_{XF}, −L_{YF}). The center positions D, E, and F represent a positional relationship between the second disk cutter 132 and the core 502c in the XY coordinate system U132.

As illustrated in FIG. 10(b), the center positions D, E, and F are on the circumference of a circle J2 having its center on the center O2′ of the core 502c and the radius (W1′+W2). The center and the radius of the circle J2 can be calculated from the coordinates of the center positions D, E, and F (see the description of the calculations from the center positions A to C with reference to FIG. 10(a)).

As described above and illustrated in FIG. 10(b), a substantially left half arc of the circle J2 having the center and the radius thus calculated will serve as the orbital path R42 on which the second disk cutter 132 travels, while cutting, without damaging the core 502c. The path R42 is defined by the XY coordinates in the XY coordinate system U132. Subsequently, the second disk cutter 132 starts traveling from the starting point at the center C2 and then on the orbital path R42, which has been obtained, as illustrated FIG. 10(b), so that the second disk cutter 132 can cut the insulating layer 502b, which is the cover layer, without damaging the core 502c.

As described above, even when the center O2′ of the core 502c is deviated from the specified center O2, the second disk cutter 132 can cut the insulating layer 502b without damaging the core 502c by measuring the positional relationship between the second disk cutter 132 and the core 502c and obtaining the path R42 with respect to the center C2 of the second disk cutter 132.

As described above and illustrated in FIGS. 10(a) and 10(b), even when there are errors in installation of the first disk cutter 131 and the second disk cutter 132, and when the center position and the radius of the actual core 502c are deviated from their specifications and unknown, the detecting device is used to measure the positional relationships between the first disk cutter 131 and the core 502c and between the second disk cutter 132 and the core 502c to obtain the discrete paths with respect to the center of the first disk cutter 131 and the center of the second disk cutter 132, respectively. When the paths have been obtained, the first disk cutter 131 and the second disk cutter 132 of the cover-layer cutting apparatus according to the invention travel on the discrete orbital paths, which have been obtained, to achieve a slit in the insulating layer 502b, which is the cover layer, along the entire circumference of the electric wire 502 without damaging the core 502c.

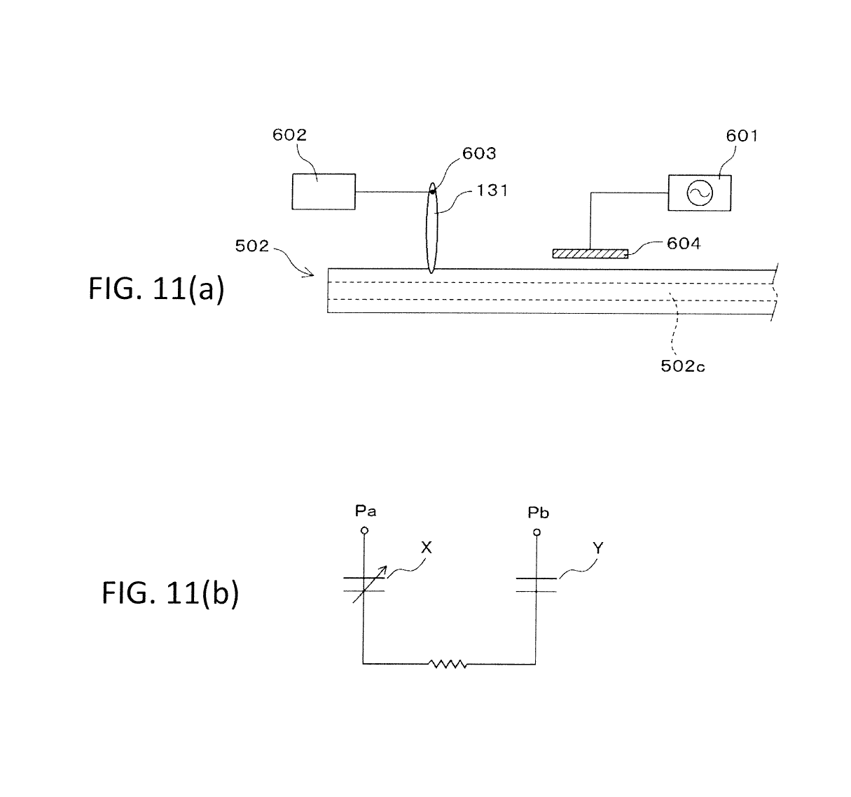

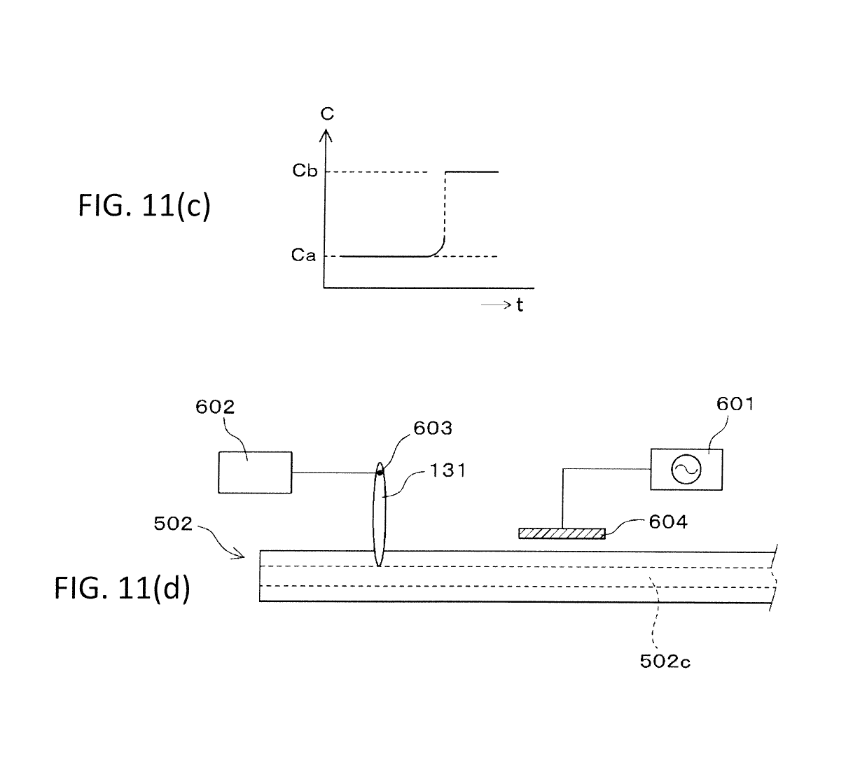

With reference to FIGS. 11(a) to 11(d), an arrangement of the detecting device 600 will now be described in detail. The detecting device 600 includes an AC power supply device 601, a planar electrode element 604 connected electrically to the AC power supply device 601, and a detector 602 connected electrically by a connector 603 to the disk cutter 131 for detecting a change in capacitance between the electrodes of the disk cutter 131 and the electrode element 604.

As illustrated in FIG. 11(a), a predetermined alternating current is passed as a measurement signal from the AC power supply device 601 to a sender, which is one of the disk cutter 131 and the electrode element 604 (the electrode element 604 in FIG. 11(a)), with the electrode element 604, such as an electrode plate, placed in proximity to a side of the electric wire 502. The current passed to a receiver, which is the other of the two (the disk cutter 131 in FIG. 11(a)), can be detected to determine an initial capacitance (Ca in FIG. 11(c)) between the electrode element 604, which is an electrode, and the disk cutter 131, which is an electrode. A circuit illustrated in FIG. 11(b) is formed between the electrodes in this case, with X representing a capacitor formed between the disk cutter 131 and the core 502c and Y representing a capacitor formed between the electrode element 604 and the core 502c.

As the disk cutter 131 is fed from a state illustrated in FIG. 11(a) and cuts further the cover layer of the electric wire 502 to approach the core 502c, the capacitance starts increasing as illustrated in FIG. 11(c), so that the approach of the disk cutter 131 so close to the core 502c that contact is about to be made can be detected. Upon the contact between the disk cutter 131 and the core 502c as illustrated in FIG. 11(d), the capacitance achieves a displacement to a capacitance (Cb in FIG. 11(c)) several times to several tens of times the initial capacitance Ca. The detector 602 then determines based on the displacement that the disk cutter 131 has come into contact with the core 502c. Note that the detector 602 is also connected electrically by a connector 605 (see FIG. 10(b)) to the disk cutter 132, so that the detector 602 can determine the contact between the disk cutter 132 and the core 502c. Although the detecting device 600, which detects a change in capacitance to determine contact between the cutter and the core, is used in this embodiment, publicly known other types of detecting device that can detect contact between a cutter and a core may be used, such as a device that detects the passage of current between a cutter and a core, which carry current, to determine the contact between the cutter and the core.

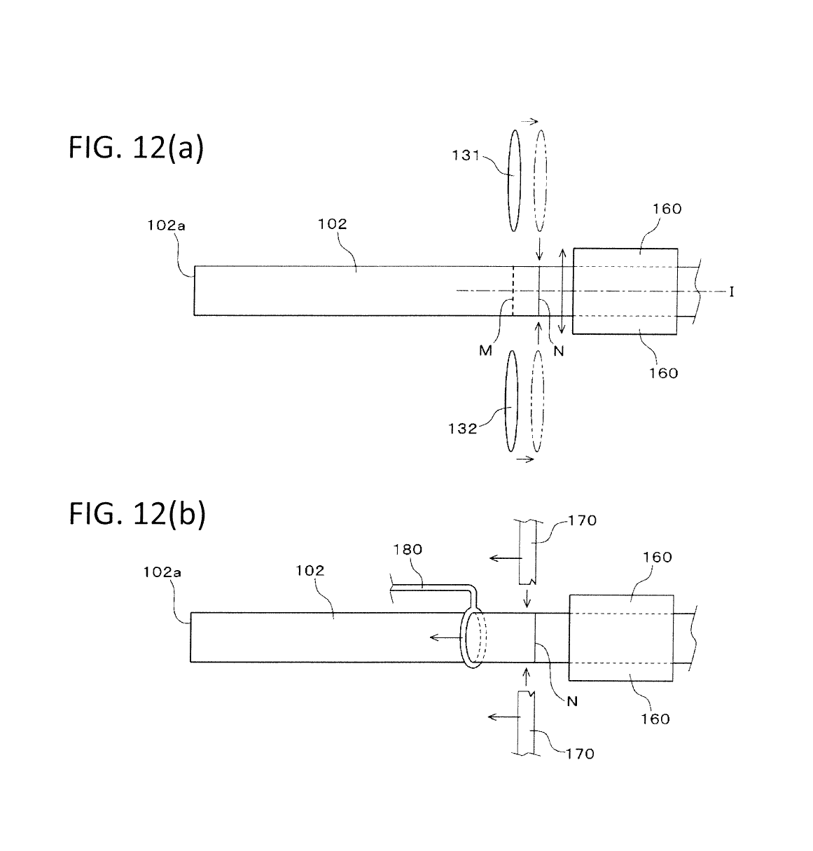

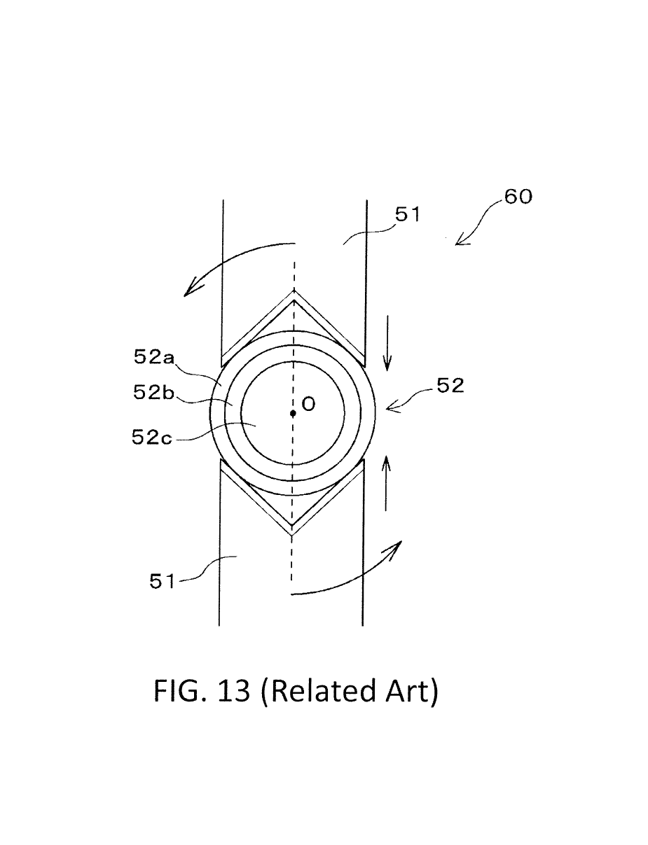

With reference to FIGS. 12(a) and 12(b), a process of pulling an end section of the cover layer off the electric wire, which is performed after the cover layer is cut by the first and second disk cutters traveling on the discrete paths obtained in FIGS. 10(a) and 10(b), will now be described in detail.

FIG. 12(a) is an enlarged view of the electric wire 102 illustrated in FIG. 8 and its surroundings, observed from a side of the electric wire (in the X direction). A case is assumed in which a slit N is to be provided at a position away from an end 102a of the electric wire 102. A tubular collet 160 is adapted to hold the electric wire 102 therearound.

If a disk cutter designed to travel around the electric wire 102 in 360 degrees is used to provide the slit N at the position away from the end 102a as illustrated, a component that holds the disk cutter (for example, an arm 136 for holding the disk cutters illustrated in FIG. 8), or other components of the cover-layer cutting apparatus, may interfere with the electric wire 102. Such a disk cutter may require a complex arrangement to prevent an interference during the travel of the disk cutter around the electric wire 102 in 360 degrees. In contrast, the first disk cutter 131 travels along a substantially half of the circumference of the electric wire 102 above a central axis I, and the second disk cutter 132 travels along a substantially half of the circumference of the electric wire 102 below the central axis I as illustrated in FIG. 12(a) to provide a slit. The disk cutters, each of which does not travel around the electric wire 102 in 360 degrees, thus cause no interference between the apparatus and the electric wire, allowing for simplicity in the arrangement of the apparatus.

A pre-cutting position M is at the front of the slit N in FIG. 12(a). The pre-cutting position M is where the orbital paths of the disk cutters are obtained as illustrated in FIGS. 10(a) and 10(b). In other words, the disk cutters cut the cover layer of the electric wire at this position to obtain the paths. As described above with reference to FIGS. 10(a) and 10(b), the disk cutters, while traveling on the orbital paths obtained at the pre-cutting position M, can cut the cover layer without damaging the core having a deviated center. The first and second disk cutters travel on the orbital paths, which have been obtained in advance, to provide the slit N at a position slightly toward the back of the pre-cutting position M. As described above, the orbital paths for the disk cutters are previously obtained at a position slightly toward the front of the slit N before the slit N is provided.

As illustrated in FIG. 12(b), after the slit N has been provided, a stripping blade 170 is inserted into the slit N vertically. The stripping blade 170, as inserted, is then moved toward the end 102a of the electric wire 102 to strip the end section of the cover layer only, leaving the core behind. The end section of the electric wire 102, which extends from the slit N to the end of the electric wire 102, may dangle due to the weight of the electric wire 102 because of the slit N provided away from the end 102a of the electric wire 102. Moving the stripping blade 170 toward the end 102a with the electric wire 102 dangling results in load, due to the weight of the electric wire 102, applied to the stripping blade 170, leading to increased resistance while the end section of the cover layer is being pulled off. Additionally, the stripping blade 170 may damage the core while the end section is being pulled off.

As a solution to the problems described above, a supporting ring 180 is provided at the front of the stripping blade 170 as illustrated in FIG. 12(b). The supporting ring 180, which is shaped into a ring that allows the electric wire 102 to pass therethrough, prevents the electric wire 102 from dangling. The supporting ring 180 moves in conjunction with the stripping blade 170 toward the end 102a and thus precludes the application of the load due to the weight of the electric wire 102 to the stripping blade 170 while the end section of the cover layer is being pulled off. The stripping blade 170 and the supporting ring 180 are controlled by a device, such as a motor, so as to be able to move to any positions in the axial direction of the electric wire.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A cover-layer cutting apparatus configured to provide a slit in a cover layer of an insulated electric wire, the apparatus comprising:
a disk cutter adapted to cut the cover layer of the electric wire;
a lifting unit adapted to raise and lower the disk cutter in an up-and-down direction (Y-axis direction); and
a traversing unit adapted to advance and retract the disk cutter in a right-and-left direction (X-axis direction),
wherein the disk cutter is moved by the lifting unit and the traversing unit so that the disk cutter is configured to travel on an orbital path along an outer periphery of the electric wire while the disk cutter cuts the cover layer of the electric wire, and
the cover-layer cutting apparatus is configured to shift a contact point of the disk cutter with the cover layer during slit formation in the cover layer of the electric wire.

2. The cover-layer cutting apparatus according to claim 1, wherein the disk cutter comprises a first disk cutter and a second disk cutter each adapted to travel on an orbital path along a substantially half of an outer periphery of a core of the electric wire, and
the first disk cutter is configured to cut the cover layer along substantially half of a circumference of the cover layer and the second disk cutter is configured to cut the cover layer along substantially the remaining half of the circumference of the cover layer, so that a slit is provided along the entire circumference of the cover layer.

3. The cover-layer cutting apparatus according to claim 2, further comprising a detecting device adapted to detect contact between the core of the electric wire and the first and second disk cutters respectively,
wherein the cover-layer cutting apparatus is configured to determine a positional relationship between the core and each of the disk cutters when the detecting device detects contact between the core of the electric wire and the first and/or second disk cutters, and
the cover-layer cutting apparatus is configured to calculate an orbital path on which each of the disk cutters travels along a substantially half of the outer periphery of the core of the electric wire, the orbital paths being based on the respective positional relationships.

4. The cover-layer cutting apparatus according to claim 1, wherein the disk cutter is provided with a rotating device and rotates around a central point of the at least one disk cutter in any direction at any speed.

5. The cover-layer cutting apparatus according to claim 2, wherein the first and second disk cutters are independently provided with a rotating device and rotates around a central point of the at least one disk cutter in any direction at any speed.

6. The cover-layer cutting apparatus according claim 3, wherein the first and second disk cutters are independently provided with a rotating device and rotates around a central point of the at least one disk cutter in any direction at any speed.

7. The cover-layer cutting apparatus according to claim 2, wherein the first and second disk cutters are coaxially aligned.

8. The cover-layer cutting apparatus according to claim 2, wherein edges of first and second disk cutters that are configured for cutting the cover-layer are co-planar.

9. The cover-layer cutting apparatus according to claim 7, wherein edges of first and second disk cutters that are configured for cutting the cover-layer are co-planar.

10. The cover-layer cutting apparatus according to claim 9, wherein the edges of first and second disk cutters that are configured for cutting independently comprise a concave shape.

11. The cover-layer cutting apparatus according to claim 2, wherein edges of first and second disk cutters that are configured for cutting independently comprise a concave shape.
